(19) United States
(12) Patent Application Publication
(10) Pub. No.: US 2006/0106508 A1
(43) Pub. Date: May 18, 2006

(54) Remote display of diagnostic data apparatus and method

(75) Inventors: Troy Liebl, Owatonna, MN (US); Manokar Chinnadurai, Owatonna, MN (US); Edward Lipscomb, Lakeville, MN (US)

Correspondence Address: BAKER & HOSTETLER LLP;Washington Square, Suite 1100, 1050 Connecticut Avenue, N.W., WASHINGTON, DC, 20036, US

(73) Assignee: SPX Corporation

(21) Appl. No.: 10/986,317

(22) Filed: Nov. 12, 2004

(51) Int. Cl. G06F 7/00; G01M 17/00

(52) U.S. Cl. 701/29

(57) ABSTRACT

A vehicle diagnostic system couples a vehicle diagnostic tool, a remote processor, and a remote display device and provides the necessary functionality for compression, transmission, decompression and display of vehicle diagnostic data. Vehicle diagnostic data is received from a vehicle onboard computer and converted into display data, which is compressed and transmitted to the remote processor. The remote processor decompresses the vehicle diagnostic display data and displays it on the remote display device.

### FIELD OF THE INVENTION

The present invention relates generally to diagnostic equipment. More particularly, the present invention relates to the remote display of diagnostic data, such as vehicle diagnostic data, on remote display devices.

### BACKGROUND OF THE INVENTION

With the advent of the microprocessor, virtually all modern vehicles have come to utilize onboard computers to control and monitor engine and electrical system functions. Such vehicle onboard computers typically interface with a multiplicity of sensors and transducers, which continuously detect vehicle and engine operational parameters and provide representative electrical signals to the onboard computer. The data collected and processed by the onboard computer can be useful in the diagnosis of vehicle engine and electrical system malfunctions. Thus, the vehicle onboard computer typically includes a communication port connector that allows certain of the collected data to be transmitted to an independent computer analyzer, which may process the vehicle diagnostic data, store the vehicle diagnostic data, or present the vehicle diagnostic data in a visual format that can be interpreted by vehicle maintenance and repair technicians.

In conjunction with these technological developments, a variety of specialized computer analyzers, or vehicle diagnostic tools, have been developed and marketed to provide vehicle maintenance and repair technicians access to the vehicle diagnostic data available from the vehicle onboard computers. The current technology includes a variety of hand-held vehicle diagnostic tools with considerable processing capabilities, typically incorporating an integral display and capable of displaying the vehicle diagnostic data in a variety of graphical formats that allow vehicle technicians to view and interpret the data. Use of such vehicle diagnostic tools, frequently referred to as scan tools, has become the standard in vehicle diagnostics.

However, while these vehicle diagnostic tools are highly useful to an individual technician or a small number of technicians performing diagnostics on a vehicle, the typical integral displays are not useful for certain practical applications. For example, in order to train vehicle technicians, which often occurs in a group setting, a larger display capable of displaying the vehicle diagnostic data at a location more convenient than the immediate surroundings of the vehicle would be useful, because a group of trainees could observe the vehicle diagnostic data on the remote display and an instructor could specify and discuss parameters of interest during an actual vehicle diagnostic session.

As a second example, the capability to display the vehicle diagnostic data at a site remote from the vehicle location would be useful for remote diagnostic analysis by expert technicians, who could interpret and analyze the data, and provide diagnostic analysis to the vehicle technician performing the maintenance or repair operations. As a final example, the capability to capture actual scan tool display screen images for inclusion in technical documents, such as scan tool users manuals or maintenance manuals, would be useful. Accordingly, it is desirable to provide a method and apparatus that is capable of remotely displaying vehicle diagnostic data from a vehicle diagnostic tool on a remote display device.

### SUMMARY OF THE INVENTION

The foregoing needs are met, to a great extent, by the present invention, wherein in one aspect an apparatus and method is provided that in some embodiments remotely displays vehicle diagnostic data from a vehicle diagnostic tool on a remote display device.

In accordance with one embodiment of the present invention, a vehicle diagnostic system has been adapted to remotely display diagnostic data by linking a vehicle diagnostic tool to a remote processor, which in turn is linked to a remote visual display device. The vehicle diagnostic tool is connected to and receives diagnostic data from an onboard vehicle computer, and converts the received onboard vehicle computer data into display data. The vehicle diagnostic tool then sends at least a portion of the display data to the remote processor. The remote processor receives the sent display data, and displays the sent display data on the remote visual display device.

In accordance with this aspect of the present invention, the vehicle diagnostic tool may incorporate a processor, and the vehicle diagnostic tool may be hand-held or portable. In addition, the vehicle diagnostic tool may be linked to the remote processor by a wireless network, and the display data may be sent to the remote processor via a wireless transmission protocol. Furthermore, the vehicle diagnostic tool may be connected to the remote processor by way of a two-way communication network, allowing the remote processor to provide control data to the vehicle diagnostic tool.

Further in accordance with this aspect of the present invention, the vehicle diagnostic tool may convert diagnostic data received from the onboard vehicle computer into a graphical coordinate data file, and compress part or all of this file into a compressed graphical coordinate data file. In this case, the vehicle diagnostic tool sends part or all of the compressed graphical coordinate data file to the remote processor, which receives the sent compressed graphical coordinate data file and decompresses at least a portion of this file in order to create an output diagnostic data file compatible with the remote visual display device. This output diagnostic data file is then displayed on the remote visual display device.

This process may occur on a real-time basis, or on a near real-time basis, or at a delayed or reduced-rate basis. Thus, the vehicle diagnostic tool may periodically compress the graphical coordinate data file and send the resulting compressed graphical coordinate data file to the remote processor each time the graphical coordinate data file is updated, or at a lesser rate than the frequency with which the graphical coordinate data file is updated.

In accordance with another aspect of the present invention, a method of remotely displaying vehicle diagnostic data includes reading at least a portion of a vehicle diagnostic tool graphical coordinate data file from a computer-readable binary pattern storage apparatus, executing a data compression algorithm program on at least a portion of the read graphical coordinate data file in order to create a compressed graphical coordinate data file, and sending the compressed graphical coordinate data file to a remote processor. This method further entails receiving the sent compressed graphical coordinate data file, executing a data decompression algorithm program on at least a portion of this received file in order to create an output diagnostic data file that is compatible with an associated remote visual display device, and displaying the output diagnostic data file on the remote visual display device.

Once again, in accordance with this aspect of the present invention, the method may include sending the compressed graphical coordinate data file to the remote processor via a wireless transmission communication network. Likewise, this method may include the remote processor sending control data and the vehicle diagnostic tool receiving the control data. Additionally, this method may periodically repeat one or more of the recited steps as the graphical coordinate data file is updated, or at a lesser rate than the frequency with which this file is updated.

In accordance with yet another aspect of the present invention, a vehicle diagnostic system adapted to remotely display diagnostic data includes means for reading at least part of a vehicle diagnostic tool graphical coordinate data file from a computer-readable binary pattern storage apparatus, as well as means for executing a data compression algorithm program on at least part of the read graphical coordinate data file to generate a compressed graphical coordinate data file. The vehicle diagnostic system also includes means for sending the compressed graphical coordinate data file to a remote processor, which is linked to a remote visual display device. The vehicle diagnostic system further includes means for receiving the sent compressed graphical coordinate data file and means for executing a data decompression algorithm program on at least part of the received compressed graphical coordinate data file to generate an output diagnostic data file compatible with the remote visual display device. In addition, the vehicle diagnostic system includes means for displaying the output diagnostic data file on the remote visual display device.

Further in accordance with this aspect of the present invention, the vehicle diagnostic system may utilize wireless transmission means for sending the compressed graphical coordinate data file to the remote processor. The vehicle diagnostic system may also include means for sending control data from the remote processor, along with means for receiving the sent control data. Additionally, the vehicle diagnostic system may include means for periodically reading at least part of a periodically updated vehicle diagnostic tool graphical coordinate data file, means for periodically executing the data compression algorithm program on at least part of the read graphical coordinate data file to generate a compressed graphical coordinate data file, and means for periodically sending the compressed graphical coordinate data file to the remote processor. Once again, these processes may be repeated at the same frequency with which the graphical coordinate data file is updated, or at a lesser frequency.

In accordance with still another embodiment of the present invention, a computer program product for enabling a vehicle diagnostic tool to remotely display diagnostic data comprises software instructions for enabling a microprocessor-based vehicle diagnostic tool to perform predetermined operations, and a computer-readable medium bearing the software instructions. The predetermined operations include the steps of reading at least part of a vehicle diagnostic tool graphical coordinate data file from a computer-readable binary pattern storage apparatus, executing a data compression algorithm program on at least part of the read graphical coordinate data file to generate a compressed graphical coordinate data file, and sending the compressed graphical coordinate data file to a remote processor capable of decompressing and displaying at least part of the compressed graphical coordinate data file on a remote visual display device.

In accordance with still another embodiment of the present invention, a computer program product for enabling a remote processor to remotely display vehicle diagnostic data includes software instructions for enabling a processor to perform predetermined operations and a computer-readable medium bearing the software instructions. The predetermined operations implement the following steps: receiving a compressed graphical coordinate data file from a vehicle diagnostic tool; executing a data decompression algorithm program on at least part of the received compressed graphical coordinate data file to generate an output diagnostic data file compatible with a remote visual display device; and displaying the output diagnostic data file on the remote visual display device.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a block diagram of a vehicle diagnostic system adapted to remotely display vehicle diagnostic data according to a preferred embodiment of the invention.

FIG. 2 is a flowchart illustrating steps included in the method of remotely displaying vehicle diagnostic data in accordance with a second preferred embodiment of the invention.

FIG. 3 is a flowchart illustrating steps included in the method of remotely displaying vehicle diagnostic data in accordance with a third preferred embodiment of the invention.

### DETAILED DESCRIPTION

The invention will now be described with reference to the drawing figures, in which like reference numerals refer to like parts throughout.

An embodiment in accordance with the present inventive apparatus and method provides a vehicle diagnostic system adapted to remotely display vehicle diagnostic data. This embodiment of the present invention provides a vehicle diagnostic tool that receives vehicle diagnostic data from an onboard vehicle computer and converts the received data into display data, which is sent to a remote processor. The remote processor in turn receives the sent display data, which then is displayed on a remote visual display device.

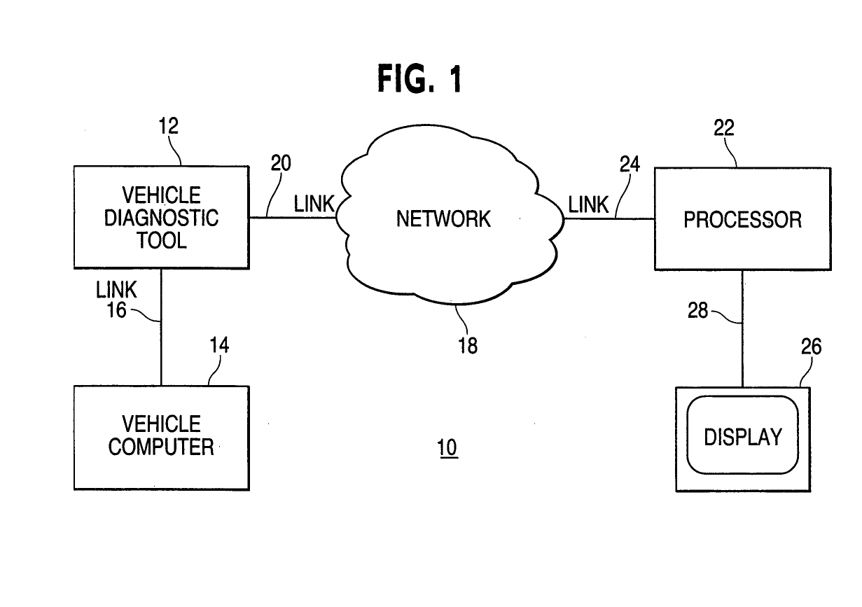

An embodiment of the present inventive apparatus and method for remotely displaying vehicle diagnostic data is illustrated in FIG. 1. In this figure, an example of a vehicle diagnostic system 10 is shown that includes a vehicle diagnostic tool 12, which receives vehicle diagnostic data from a vehicle onboard computer 14 via a first communication link 16. The vehicle diagnostic tool 12 is coupled to a communication network 18 via a second communication link 20, and a remote processor 22 also is coupled to the communication network 18 via a third communication link 24. In addition, a remote visual display device 26 is coupled to the remote processor 22 via a fourth communication link 28.

Vehicle engine operation and electrical system diagnostic data is received from the vehicle onboard computer 14. In order to be presented to the user in a visual format that is useful for diagnostic analysis of vehicle engine or electrical system operational problems, the vehicle diagnostic data is processed by an integral vehicle diagnostic tool processor and is converted into a graphical coordinate data file, which is stored in a vehicle diagnostic tool memory in a digital data format that is capable of being displayed on a visual display device. The vehicle diagnostic tool typically includes an integral display device whereon the graphical coordinate display file may be displayed to allow the user to view the vehicle diagnostic data in a useful form. In addition, the data from the graphical coordinate file may be simultaneously sent to a remote location for remote display.

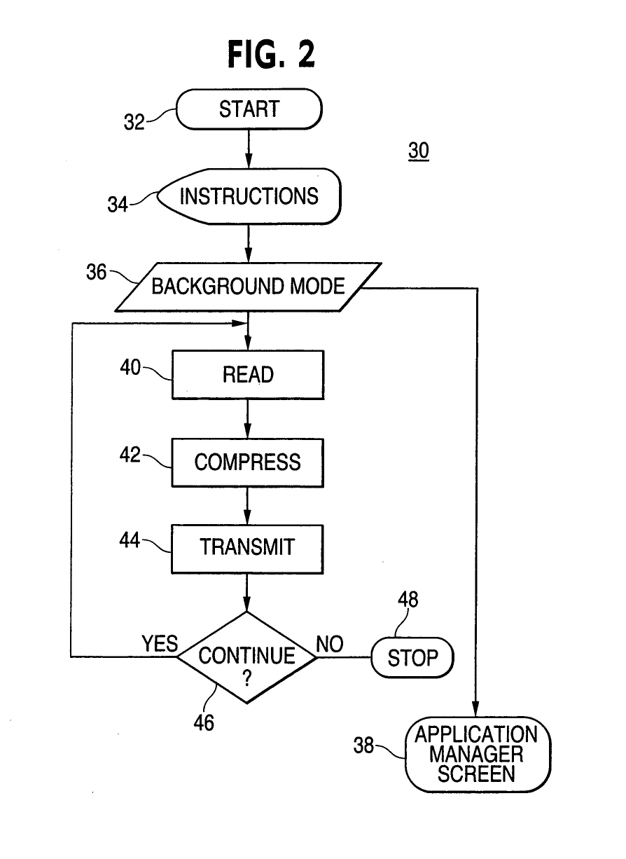

FIG. 2 depicts a flowchart outlining an example of the operation of a vehicle diagnostic tool screen capture application 30. The screen capture application 30 may be invoked by the user in order to prepare and transmit the vehicle diagnostic data for near-real-time display at a remote location. The screen capture application 30 process starts in step 32, where the vehicle diagnostic tool user enters a request for the screen capture application 30 to begin. The vehicle diagnostic tool 12 then displays instructions, in step 34, regarding the setup of the communication link 20 to the network 18 and the communication link 24 to the remote processor 22. At this point, the user must physically connect the communication link 20 to the vehicle diagnostic tool and the communication link 24 to the remote processor 22.

After the vehicle diagnostic tool is able to verify the correct function of the communication links 20, 24 and the network 18, and communication with the remote processor 22 via the network 18 and communication links 20, 24 has been established, the screen capture application 30 continues to operate in background mode, in step 36, and the vehicle diagnostic tool display returns to its former state, an application manager screen, in step 38. The user may then continue performing normal vehicle diagnostic operations, viewing the vehicle diagnostic data on the vehicle diagnostic tool display in the same manner that the vehicle diagnostic data is viewed when the screen capture application 30 is not operating. Meanwhile, remote viewers may simultaneously observe the same vehicle diagnostic data on a visual display device at a remote location.

Once in background mode, the screen capture application 30 enters a loop wherein the graphical coordinate data file is read, in step 40, from the vehicle diagnostic tool display buffer memory and is compressed, in step 42, by a compression algorithm program to reduce the amount of digital data required to represent the vehicle diagnostic data. Continuing in the loop, the compressed graphical coordinate data file is transmitted, in step 44, to the remote processor 22 via the network 18 and the associated communication links 20,24. The screen capture application 30 then determines whether to continue, in step 46; if the vehicle diagnostic tool remains in remote display mode, the screen capture application 30 repeats the loop, steps 40-46. Otherwise, if the vehicle diagnostic tool is no longer in remote display mode, the screen capture application 30 terminates, in step 48.

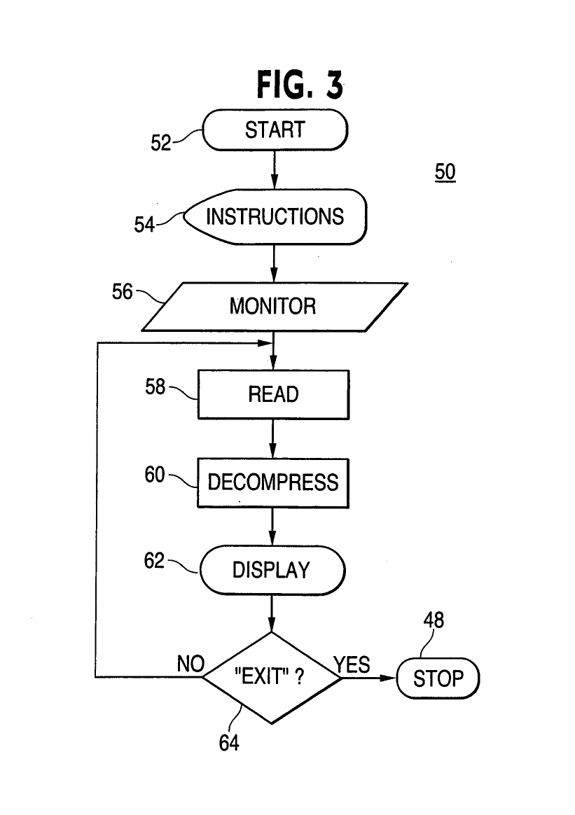

The transmitted compressed graphical coordinate data file is received by the remote processor 22 and displayed on the remote visual display device 26. FIG. 3 depicts a flowchart outlining an example of the operation of a remote processor screen host application 50. The screen host application 50 runs on the remote processor 22 to perform the necessary operations for receiving and remotely displaying the vehicle diagnostic data. The screen host application 50 starts in step 52, where the remote processor user enters a request for the screen host application 50 to begin. The remote processor 22 then displays instructions, in step 54, on the remote display device 26 requesting user input regarding the type of network 18 and communication link 24 being used. After the requested connection information is entered by the user, the screen host application 50 begins monitoring, in step 56, the communication link 24 for transmitted data from the vehicle diagnostic tool 12.

When transmitted data is detected from the communication link 24, the screen host application 50 enters a loop wherein the compressed graphical coordinate data file is read, in step 58, from the communication link 24 and is decompressed, in step 60, by a decompression algorithm program that generates an output diagnostic data file in a digital data format that is capable of being displayed on a visual display device. Continuing in the loop, the remote processor 22 displays, in step 62, the output diagnostic data file on the remote visual display device 26 by way of the communication link 28. The screen host application 50 then determines, in step 64, whether the user has requested that the remote processor exit the screen host application 50; if not, the screen host application 50 repeats the loop 58-64. Otherwise, if the user has requested that the remote processor exit the screen host application 50, the screen host application 50 terminates in step 66.

In accordance with a preferred embodiment of the present invention, the vehicle diagnostic tool 12 includes a processor with sufficient processing capability to receive the vehicle onboard data and both process the data for display on an integral display screen, as well as periodically perform the display data compression algorithm at a sufficient frequency to produce a useful result, such as near real-time remote display. In addition, the vehicle diagnostic tool processor is capable of executing the screen capture application 30 in the background while actively executing and displaying a scan diagnostic application. Thus, in accordance with a preferred embodiment of the present invention, the processor further is capable of performing multitasking, cooperative task sharing or multithreading functions.

A preferred embodiment of the present invention includes the Genisys vehicle diagnostic scan tool, manufactured by SPX Corporation, a hand-held instrument designed to operate software applications developed for automotive diagnostics, which incorporates a Motorola Power PC 823 processor and a color graphics LCD display. A variety of features of the Genisys system are disclosed in additional U.S. patents, such as U.S. Pat. No. 6,640,166, U.S. Pat. No. 6,538,472 and U.S. Pat. No. 6,662,087, the disclosure of which is incorporated herein by reference. However, in other embodiments the vehicle diagnostic tool can be one of any number of commercially available makes and models, including the StarSCAN scan tool, manufactured by DaimlerChrysler Corporation; the SUPER AutoScanner, manufactured by Actron Inc.; the EZ 3/4/5/6000 Scan Tools, manufactured by Auto Xray, Inc.; or the Snap-on Scanner, MicroSCAN, MODIS, or SOLUS series, manufactured by Snap-on Technologies, Inc.; or any other device capable of receiving and processing vehicle diagnostic data from a vehicle onboard computer.

A preferred embodiment of the present invention communicates information to the user and requests user input by way of an interactive, menu-driven, visual display-based user interface. The vehicle diagnostic tool 12 includes several buttons, or keys, with which the user may interactively input information or select menu items, such as the desired scan diagnostic application or the screen capture application 30. Nevertheless, any number of additional functional user interface schemes could be incorporated in the present invention in place of this interface scheme, with or without the use of an integral visual display device or buttons or keys, including a voice-activated system.

In a preferred embodiment of the present inventive apparatus and method, the screen capture application 30 can be initiated only after a vehicle diagnostic tool 12 scan diagnostic application has been launched. However, in other embodiments the screen capture application 30 could be launched before a scan diagnostic application has been initiated. In yet other embodiments, the screen capture application 30 could be launched either before or after a scan diagnostic application has been initiated.

A preferred embodiment of the present invention utilizes a data compression algorithm of the ZLIB compression format, according to rfc1950. However, the present invention is not dependent on nor highly sensitive to the specific data compression algorithm used. Thus, any number of available data compression algorithms or file compression utilities would suffice for the screen capture application, such as the Lempel-Ziv algorithm, MMP5, MMP7, V.42bis, COMPRESS, ZIP, CCIT Group 3, JPEG, GIF, MPEG or other lossless or lossy data compression schemes.

The example of a communication network 18 shown in FIG. 1 is a direct cable connection between the vehicle diagnostic tool 12 and the remote processor 22. However, in other embodiments the network 18 can be any viable combination of devices and systems capable of linking computer-based systems, including a private network; a public network; a local area network (LAN); a wide area network (WAN); an Ethernet-based system; a token ring; the Internet; an intranet or extranet; a value-added network; a telephony-based system, including T1 or E1 devices; an Asynchronous Transfer Mode (ATM) network; a wired system; a wireless system; an optical system; a combination of any number of distributed processing networks or systems; etc.

Similarly, the various examples of communication links 16, 20, 24, 28 shown in FIG. 1 are direct cable connections utilizing the RS-232 serial communication protocol, but other embodiments may incorporate any combination of devices, as well as any associated software or firmware, configured to couple processor-based systems, including modems, network interface cards, serial buses, parallel buses, LAN or WAN interfaces, wireless or optical interfaces and the like, along with any associated transmission protocols, as may be desired or required by the design.

The example of a remote processor 22 shown in FIG. 1 is a common personal computer (PC). However, in other embodiments the remote processor 22 may take on any number of forms, such as a server, a personal computer, a collection of networked servers or personal computers, a mainframe computer, etc. Likewise, in other embodiments the remote display 26—shown in FIG. 1 as a common PC monitor, independent from the remote processor—may be any compatible visual display device, integral to or independent of the remote processor, including a cathode ray tube (CRT) monitor, a liquid crystal diode (LCD) display, a television screen, etc.

In a preferred embodiment of the present invention, the remote display is capable of displaying the vehicle diagnostic display data in a format approximately the size of the vehicle diagnostic tool integral display, or the user may select a “zoom” option to enlarge the vehicle diagnostic display data to twice this size. In additional embodiments of the present invention, the remote display may be capable of showing the display data in any variety of sizes or display formats.

In another embodiment of the present inventive apparatus and method, software source or object code residing on a memory medium in a digital format that may be transmitted or downloaded onto a vehicle diagnostic tool (which is not included in this embodiment) provides the functionality required of a vehicle diagnostic tool for reading and transmitting vehicle diagnostic data received from a vehicle onboard computer for remote display. The software code includes the screen capture application 30, shown in FIG. 2, which starts in step 32, where a vehicle diagnostic tool user enters a request for the screen capture application 30 to begin. Instructions are displayed, in step 34, regarding the setup of a communication link with a remote processor (neither of which is included in this embodiment).

Then, the screen capture application 30 attempts to verify a functional communication link with a remote processor (which is not included in this embodiment). If communication can be established, the screen capture application 30 continues to operate in background mode, in step 36, allowing the vehicle diagnostic tool display to return to its former state. The user may then continue performing normal vehicle diagnostic operations, in the same manner that vehicle diagnosis is performed when the screen capture application 30 is not installed. Meanwhile, the vehicle diagnostic data is transmitted to a remote processor (which is not included in this embodiment).

Once in background mode, the screen capture application 30 enters a loop wherein a graphical coordinate data file is read, in step 40, from a vehicle diagnostic tool display buffer memory and is compressed, in step 42, by a compression algorithm program to reduce the amount of digital data required to represent the vehicle diagnostic data. Continuing in the loop, the compressed graphical coordinate data file is transmitted, in step 44, to a remote processor (which is not included in this embodiment). The screen capture application 30 then determines whether to continue, in step 46; if the vehicle diagnostic tool remains in remote display mode, the screen capture application 30 repeats the loop, steps 40-46. Otherwise, if the vehicle diagnostic tool is no longer in remote display mode, the screen capture application 30 terminates, in step 48.

In another embodiment of the present inventive apparatus and method, software source or object code residing on a memory medium in a digital format that may be transmitted or downloaded onto a remote processor (which is not included in this embodiment) provides the functionality required of a remote processor for receiving and displaying vehicle diagnostic data on a remote display (which is not included in this embodiment). The software code includes the screen host application 50, shown in FIG. 3, which starts in step 52, where a remote processor user enters a request for the screen host application 50 to begin. Instructions are displayed, in step 54, requesting user input regarding the type of communication link or network being used (although the communication link and network are not included in this embodiment). After the requested connection information is entered by the user, the screen host application 50 attempts, in step 56, to detect data arriving from a vehicle diagnostic tool (which is not included in this embodiment).

When arriving vehicle diagnostic data is detected, the screen host application 50 enters a loop wherein the received compressed graphical coordinate data file is read, in step 58, and is decompressed, in step 60, by a decompression algorithm program that generates an output diagnostic data file in a digital data format that is capable of being displayed on a visual display device. Continuing in the loop, the output diagnostic data file is displayed, in step 62, on a remote visual display device (which is not included in this embodiment). The screen host application 50 then determines, in step 64, whether the user has requested that the screen host application 50 be discontinued; if not, the screen host application 50 repeats the loop 58-64. Otherwise, if the user has requested that the screen host application 50 be discontinued, the screen host application 50 terminates in step 66.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A vehicle diagnostic system adapted to remotely display diagnostic data, comprising:
(a) a vehicle diagnostic tool for receiving data from an onboard vehicle computer and converting the data into display data;
(b) a communication network linked to the vehicle diagnostic tool for transmitting at least part of the display data;
(c) a remote processor linked to the communication network for receiving the sent display data; and
(d) a remote visual display device linked to the remote processor for displaying the display data.

2. The vehicle diagnostic system of claim 1, wherein the vehicle diagnostic tool further comprises a processor.

3. The vehicle diagnostic system of claim 1, wherein the vehicle diagnostic tool is hand-held.

4. The vehicle diagnostic system of claim 1, wherein the communication network further comprises a wireless transmission medium.

5. The vehicle diagnostic system of claim 1, wherein the remote processor is configured to send control data to the vehicle diagnostic tool and the vehicle diagnostic tool is configured to receive the sent control data.

6. The vehicle diagnostic system of claim 1, wherein the vehicle diagnostic tool is configured to convert the received onboard vehicle computer data into a graphical coordinate data file and execute a data compression algorithm program on at least part of the graphical coordinate data file to generate a compressed graphical coordinate data file;
the vehicle diagnostic tool is configured to send at least part of the compressed graphical coordinate data file to the remote processor by way of the communication network;
the remote processor is configured to receive the sent compressed graphical coordinate data file and execute a data decompression algorithm program on at least part of the received compressed graphical coordinate data file to generate an output diagnostic data file compatible with the remote visual display device.

7. The vehicle diagnostic system of claim 6, wherein the vehicle diagnostic tool is configured to periodically update the graphical coordinate data file, periodically compress the updated graphical coordinate data file, and periodically send the compressed periodically updated graphical coordinate data file to the remote processor.

8. The vehicle diagnostic system of claim 7, wherein the vehicle diagnostic tool is configured to periodically send the compressed periodically updated graphical coordinate data file to the remote processor at a lesser rate than the frequency with which the graphical coordinate data file is updated.

9. A method of remotely displaying vehicle diagnostic data, comprising the steps of:
(a) reading at least part of a vehicle diagnostic tool graphical coordinate data file from a computer-readable binary pattern storage apparatus;
(b) executing a data compression algorithm program on at least part of the read graphical coordinate data file to generate a compressed graphical coordinate data file;
(c) sending the compressed graphical coordinate data file to a remote processor linked to a remote visual display device;
(d) receiving the sent compressed graphical coordinate data file;
(e) executing a data decompression algorithm program on at least part of the received compressed graphical coordinate data file to generate an output diagnostic data file compatible with the remote visual display device; and
(f) displaying the output diagnostic data file on the remote visual display device.

10. The method of claim 9, wherein the compressed graphical coordinate data file is sent to the remote processor by wireless transmission.

11. The method of claim 9, further comprising the steps of:
(a) sending control data from the remote processor; and
(b) receiving the sent control data.

12. The method of claim 9, wherein at least one step periodically is repeated.

13. The method of claim 12, wherein at least one step periodically is repeated at a lesser rate than the frequency with which a periodically updated graphical coordinate data file is updated.

14. A vehicle diagnostic system adapted to remotely display diagnostic data, the system comprising:
(a) means for reading at least part of a vehicle diagnostic tool graphical coordinate data file from a computer-readable binary pattern storage apparatus;
(b) means for executing a data compression algorithm program on at least part of the read graphical coordinate data file to generate a compressed graphical coordinate data file;
(c) means for sending the compressed graphical coordinate data file to a remote processor linked to a remote visual display device;
(d) means for receiving the sent compressed graphical coordinate data file;
(e) means for executing a data decompression algorithm program on at least part of the received compressed graphical coordinate data file to generate an output diagnostic data file compatible with the remote visual display device; and
(f) means for displaying the output diagnostic data file on the remote visual display device.

15. The vehicle diagnostic system of claim 14, further comprising wireless transmission means for sending the compressed graphical coordinate data file to the remote processor.

16. The vehicle diagnostic system of claim 14, further comprising:
(a) means for sending control data from the remote processor; and
(b) means for receiving the sent control data.

17. The vehicle diagnostic system of claim 14, further comprising:
(a) means for periodically reading at least part of a periodically updated vehicle diagnostic tool graphical coordinate data file from the computer-readable binary pattern storage apparatus;
(b) means for periodically executing the data compression algorithm program on at least part of the read graphical coordinate data file to generate a compressed graphical coordinate data file; and
(c) means for periodically sending the compressed graphical coordinate data file to the remote processor.

18. The vehicle diagnostic system of claim 17, wherein the compressed graphical coordinate data file periodically is sent to the remote processor at a lesser rate than the frequency with which the graphical coordinate data file is updated.

19. A computer program product for enabling a vehicle diagnostic tool to remotely display diagnostic data, comprising:
(a) software instructions for enabling a microprocessor-based vehicle diagnostic tool to perform predetermined operations; and
(b) a computer-readable medium bearing the software instructions;
the predetermined operations comprising the steps of:
(a) reading at least part of a vehicle diagnostic tool graphical coordinate data file from a computer-readable binary pattern storage apparatus;
(b) executing a data compression algorithm program on at least part of the read graphical coordinate data file to generate a compressed graphical coordinate data file; and
(c) sending the compressed graphical coordinate data file to a remote processor capable of decompressing and displaying at least part of the compressed graphical coordinate data file on a remote visual display device.

20. The computer program product of claim 19, further comprising software instructions for enabling a hand-held microprocessor-based vehicle diagnostic tool to perform the predetermined operations.

21. The computer program product of claim 19, wherein the compressed graphical coordinate data file is sent to the remote processor by wireless transmission.

22. The computer program product of claim 19, wherein the predetermined operations further comprise the step of receiving control data from the remote processor.

23. The computer program product of claim 19, wherein at least one of the predetermined operations periodically is repeated.

24. The computer program product of claim 19, wherein at least one of the predetermined operations periodically is repeated at a lesser rate than the frequency with which a periodically updated graphical coordinate data file is updated.

25. A computer program product for enabling a remote processor to remotely display vehicle diagnostic data, comprising:
(a) software instructions for enabling a processor to perform predetermined operations; and
(b) a computer-readable medium bearing the software instructions;
the predetermined operations comprising the steps of:
(a) receiving a compressed graphical coordinate data file from a vehicle diagnostic tool;
(b) executing a data decompression algorithm program on at least part of the received compressed graphical coordinate data file to generate an output diagnostic data file compatible with a remote visual display device; and
(c) displaying the output diagnostic data file on the remote visual display device.

26. The computer program product of claim 25, wherein the predetermined operations further comprise the step of receiving a compressed graphical coordinate data file from a microprocessor-based vehicle diagnostic tool.

27. The computer program product of claim 25, wherein the predetermined operations comprise the step of receiving a compressed graphical coordinate data file from a hand-held vehicle diagnostic tool.

28. The computer program product of claim 25, wherein the compressed graphical coordinate data file is received by wireless transmission.

29. The computer program product of claim 25, wherein the predetermined operations comprise the step of sending control data to the vehicle diagnostic tool.
